(19) United States
(12) Patent Application Publication
(10) Pub. No.: US 2023/0095828 A1
(43) Pub. Date: Mar. 30, 2023

(54) IMAGING DEVICE, CAMERA MODULE, ELECTRONIC DEVICE, AND IMAGING SYSTEM

(71) Applicants: SONY SEMICONDUCTOR SOLUTIONS CORPORATION, KANAGAWA (JP); SONY GROUP CORPORATION, TOKYO (JP)

(72) Inventors: KATSUJI KIMURA, KANAGAWA (JP); HIDEAKI OKANO, TOKYO (JP)

(21) Appl. No.: 17/759,435

(22) PCT Filed: Jan. 18, 2021
(86) PCT No.: PCT/JP2021/001415

§ 371 Date: Jul. 25, 2022

(30) Foreign Application Priority Data
Jan. 31, 2020 (JP) 2020-015227

(51) Int. Cl. G02B 5/20; H04N 25/706

(52) U.S. Cl. CPC G02B 5/205; H04N 25/706

(57) ABSTRACT

The present disclosure relates to an imaging device, a camera module, an electronic device, and an imaging system capable of optically correcting a peripheral light amount decrease caused by an optical characteristic of a lens instead of correcting by signal processing. An optical block includes a lens and a center gradation ND filter, and in the ND filter, at least a light transmittance of a peripheral portion corresponding to an outer peripheral portion of the lens is larger than a light transmittance in a vicinity of an optical axis of the lens. The present disclosure can be applied to a biometric authentication system.

### TECHNICAL FIELD

The present disclosure relates to an imaging device, a camera module, an electronic device, and an imaging system, and more particularly, to an imaging device, a camera module, an electronic device, and an imaging system capable of optically correcting a peripheral light amount decrease caused by an optical characteristic of a lens.

### BACKGROUND ART

In recent years, in an imaging device such as a digital still camera and a mobile terminal device with a camera and a biometric authentication device, an increase in the number of pixels (increase in the number of pixels) and a reduction in the size of the camera have progressed. Then, along with the increase in the number of pixels and the reduction in the size of the camera, a reduction in the size of a solid-state imaging device including an optical system has progressed.

Under such circumstances, small aperture diffraction of a lens of an imaging optical system that captures image light (incident light) from a subject and guides the image light to an imaging surface of a solid-state imaging element occurs. In order to solve this small aperture diffraction, it is necessary to increase the aperture of the lens.

However, it is known that when the aperture of the lens is increased, a peripheral light amount decrease (light reduction) occurs which is caused by the optical characteristic of the lens and in which the light amount decreases in a peripheral portion (peripheral edge portion) of an image.

Heretofore, the above-described peripheral light amount decrease has been handled by amplifying an image signal of the peripheral portion, in which the light amount decreases, of the image by signal processing.

However, in an amplification process in the signal processing, a noise component, a flaw of the solid-state imaging element, fine dust attached to the solid-state imaging element, unevenness of the solid-state imaging element and an optical material, and the like are all emphasized, which leads to a decrease in yield of the imaging device.

Furthermore, in a camera for biometric authentication or the like combined with a light source that emits a diffracted light, the light amount in the periphery is small, the emitted light cannot be effectively captured, and thus, it is conceivable to handle this by not using a peripheral image. However, when there are many unused regions, the light amount is small, and thus erroneous detection may occur in the authentication.

On the other hand, in order to solve the problem of small aperture diffraction, a technique has been proposed in which two gradation neutral density (ND) filters having a continuously-changing light transmittance are arranged to face each other and symmetrically inserted/separated into/from an optical path to realize a light amount adjustment device having a wide variable density range (see, for example, Patent Document 1).

Furthermore, in order to alleviate the peripheral light amount decrease that may occur when the ND filter is inserted into the optical path during execution of a camera shake correction function, a technique has been proposed in which a light amount attenuation amount by the ND filter is changed according to a change in brightness, and an image shake correction range is reduced according to an increase in the light amount attenuation amount (see, for example, Patent Document 2).

Moreover, a solid-state imaging device having an ND function for correcting luminance shading of a lens has been proposed (see, for example, Patent Document 3).

### CITATION LIST

### Patent Document

### Patent Document 1: Japanese Patent Application Laid-Open No. 2007-292828

### Patent Document 2: Japanese Patent Application Laid-Open No. 2012-134771

### Patent Document 3: Japanese Patent Application Laid-Open No. 2004-201203

### SUMMARY OF THE INVENTION

### Problems to be Solved by the Invention

However, in the technique described in Patent Document 1, small aperture diffraction can be eliminated, but the peripheral light amount decrease caused by the optical characteristic of the lens is not considered.

Furthermore, in the technique described in Patent Document 2, even when the camera shake correction is performed, an imbalance of the peripheral light amount caused by applying the ND filter can be made less noticeable, but the peripheral light amount decrease caused by the optical characteristic of the lens is not considered.

Moreover, in the technique described in Patent Document 3, the ND filters having different densities are arranged similarly to a micro-lens and the like of the solid-state imaging element, but it is known that a mask device for forming the ND filter is required when the solid-state imaging element is produced and is considerably expensive. Furthermore, in the case of being formed in the solid-state imaging element, a suitable image cannot be obtained in the solid-state imaging device including a lens having a different peripheral light reduction characteristic.

The present disclosure has been made in view of such a situation, and particularly, optically corrects a peripheral light amount decrease caused by an optical characteristic of a lens.

### Solutions to Problems

An imaging device, a camera module, and an electronic device according to a first aspect of the present disclosure include: a lens that condenses incident light on an imaging surface of a solid-state imaging element that captures an image; and a filter that filters the incident light to make a light amount of the image captured by the solid-state imaging element uniform. In the filter, at least a light transmittance in a range away from an optical axis of the lens is larger than a light transmittance in a range in a vicinity of the optical axis.

In the first aspect of the present disclosure, the lens condenses incident light on an imaging surface of a solid-state imaging element that captures an image, the filter filters the incident light to make a light amount of the image captured by the solid-state imaging element uniform, and in the filter, at least a light transmittance in a range away from an optical axis of the lens is larger than a light transmittance in a range in a vicinity of the optical axis.

An imaging system according to a second aspect of the present disclosure is an imaging system including: a light projection device that projects predetermined light on a subject; and an imaging device that condenses, by a lens, incident light from the subject on which the predetermined light is projected and captures an image. The light projection device includes a filter that filters the predetermined light such that a light amount of the image of the subject captured by condensing by the lens is made uniform and projects the predetermined light on the subject.

In the second aspect of the present disclosure, the light projection device projects predetermined light on a subject, the imaging device condenses, by a lens, incident light from the subject on which the predetermined light is projected and captures an image, and in the light projection device, the filter filters the predetermined light such that a light amount of the image of the subject captured by condensing by the lens is made uniform and projects the predetermined light on the subject.

### BRIEF DESCRIPTION OF DRAWINGS

FIG. 1 is a diagram illustrating a configuration example of a camera module according to a first embodiment of the present disclosure.

FIG. 2 is a diagram illustrating a configuration example of an ND filter in the camera module of FIG. 1.

FIG. 3 is a diagram illustrating a configuration example of the ND filter in the camera module of FIG. 1.

FIG. 4 is a diagram illustrating a light amount characteristic of a general lens.

FIG. 5 is a diagram illustrating a correction example by signal processing based on the light amount characteristic of the lens.

FIG. 6 is a diagram illustrating a light transmittance of the ND filter of the present disclosure.

FIG. 7 is a diagram illustrating a method of manufacturing the ND filter of the present disclosure.

FIG. 8 is another configuration example of the ND filter.

FIG. 9 is still another configuration example of the ND filter.

FIG. 10 is a diagram illustrating a configuration example of a biometric authentication system according to a second embodiment of the present disclosure.

FIG. 11 is a diagram illustrating an imaging example by an imaging device of FIG. 10 in a case where the ND filter is not used.

FIG. 12 is a diagram illustrating a configuration example in which a center gradation ND filter is applied to the imaging device in FIG. 10.

FIG. 13 is a diagram illustrating a configuration example of a light projection device in the biometric authentication system of FIG. 10.

FIG. 14 is a diagram illustrating an example in which infrared light is projected on a user that is a subject by the light projection device in FIG. 13.

FIG. 15 is a diagram illustrating a configuration example of a camera module according to a third embodiment of the present disclosure.

FIG. 16 is a diagram illustrating a modification of the camera module of the present disclosure.

FIG. 17 is a diagram illustrating a modification of the camera module of the present disclosure.

FIG. 18 is a diagram illustrating a configuration example of an imaging device which is an example of an electronic device of the present disclosure.

### MODE FOR CARRYING OUT THE INVENTION

Preferred embodiments of the present disclosure will be described in detail below with reference to the accompanying drawings. Note that in the present specification and the drawings, components having substantially the same functional configuration are designated by the same reference numerals to omit duplicate description.

Hereinafter, modes (hereinafter, referred to as embodiments) for carrying out the present disclosure will be described. Note that the description will be given in the following order.

1. First embodiment

2. Second embodiment

3. Third embodiment

4. Modification

5. Example of application to imaging device as example of electronic device of present disclosure

### 1. First Embodiment

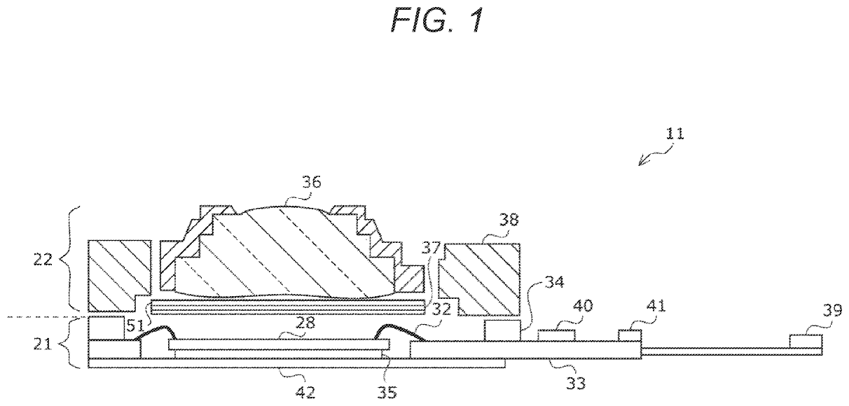

FIG. 1 is a side sectional view of a camera module to which the technique of the present disclosure is applied, the camera module optically correcting a peripheral light amount decrease caused by an optical characteristic of a lens.

A camera module 11 in FIG. 1 mainly includes, around a solid-state imaging element 31, an imaging block 21 including a mechanism for capturing an image, and an optical block 22 for forming an image of incident light incident on the imaging block 21 on an imaging surface of the solid-state imaging element 31.

In the imaging block 21, a plate 42 including a hard metal or the like for fixing the solid-state imaging element 31 is provided at the lowermost portion in the drawing, and the solid-state imaging element 31 is bonded thereon with an adhesive 35.

Furthermore, the plate 42 is provided with a circuit board 33 including a substrate material such as ceramic or glass epoxy, and the solid-state imaging element 31 and the circuit board 33 are electrically connected via a metal wire 32.

The solid-state imaging element 31 includes a charge coupled device (CCD) image sensor, a complementary metal oxide semiconductor (CMOS) image sensor, or the like, and photoelectrically converts incident light, from which an infrared light component is removed by an IRCF 37 including an ND filter 51, from a subject in units of pixels to generate an image signal.

On the circuit board 33, a connector 39 that outputs image data captured by the solid-state imaging element 31 to an external device and receives an input of a control signal from the external device to the solid-state imaging element 31, a large scale integration (LSI) 40 that outputs a pulse width modulation (PWM) signal for controlling an actuator that drives a lens 36 in the optical block 22 and has functions such as autofocus, a driver, and a controller, and a storage unit 41 that stores a correction value for correcting a variation in each pixel of the solid-state imaging element 31 are provided.

Furthermore, on the circuit board 33, a spacer 34 which is integrated with the actuator for driving the lens 36 configuring the optical block 22 and fixes a holder 38 for storing the lens 36 is provided.

The optical block 22 drives the stored lens 36 in an optical axis direction (a vertical direction in the drawing) by the actuator integrated with the holder 38, adjusts a focal length, and adjusts the incident light to form an image on the imaging surface of the solid-state imaging element 31.

Furthermore, an IR cut filter (IRCF) 37 that removes infrared light is provided between the lens 36 and the solid-state imaging element 31.

The IRCF 37 removes an infrared light component included in the incident light and transmits the incident light to the solid-state imaging element 31.

Furthermore, the neutral density (ND) filter 51 is formed in the IRCF 37, and filters and transmits the incident light to make the density of the incident light uniform with respect to the imaging surface of the solid-state imaging element 31.

More specifically, the ND filter 51 includes, for example, an absorption type ND filter, and is an optical member (optical filter) in which the light transmittance of at least a peripheral portion is larger than the light transmittance of a central portion (a peripheral portion, which includes an optical axis, within a predetermined distance from the optical axis).

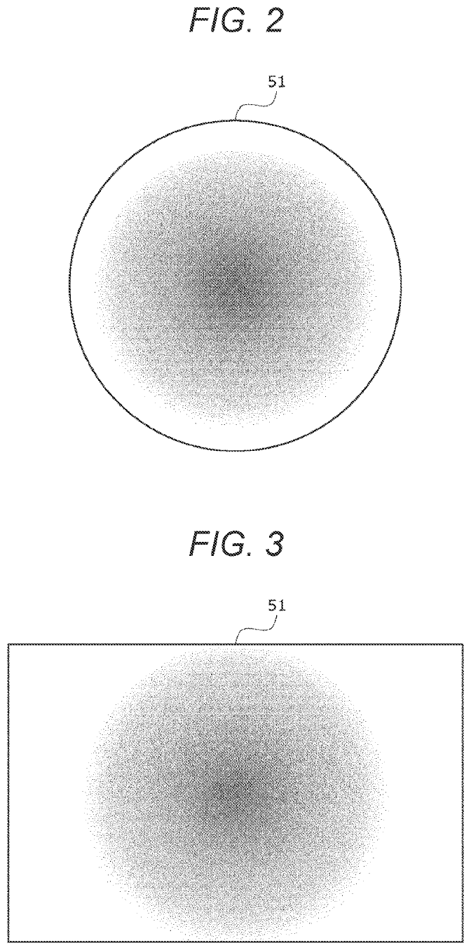

That is, for example, as illustrated in FIG. 2, the ND filter 51 is configured such that the light transmittance increases from the central portion toward the peripheral portion, and performs filtering such that the incident light closer to the optical axis among the incident light is transmitted with a lower transmittance, and the incident light closer to the peripheral portion (farther from the optical axis) is transmitted with a higher transmittance.

Note that, in FIG. 2, a change in transmittance when the ND filter 51 is viewed from the optical axis direction of the lens 36 is expressed as a color change, and the expression is made such that the light transmittance decreases when the black becomes darker, and conversely, the light transmittance increases when the black becomes lighter (whiter).

Furthermore, in FIG. 2, an example of the ND filter 51 having a disk shape centered on the optical axis of the lens 36 is illustrated. However, as long as the ND filter is configured such that the light transmittance increases from an optical center position corresponding to the optical axis of the lens 36 toward the peripheral portion, the ND filter may have a shape other than the disk shape. For example, as illustrated in FIG. 3, the ND filter may be configured to have a rectangular shape.

As described above, the ND filter 51 is an optical member (optical filter) having such a center gradation characteristic that the light transmittance gradually increases from the optical center position toward the peripheral portion.

Note that the optical characteristic as described above in which the light transmittance changes to increase in a gradation shape from the optical center position toward the peripheral portion is hereinafter referred to as a center gradation characteristic. The ND filter 51 having the center gradation characteristic as described above is also generally referred to as a gradation ND filter.

The center gradation characteristic of the light transmittance of the ND filter 51 can also be said to be an optical characteristic that the optical center position is configured to be substantially coaxial with the optical axis of the lens 36, and the light transmittance increases from the optical axis as the optical center position toward the peripheral portion, in other words, in accordance with the separation from the optical axis increases.

At this time, it is preferable that the light transmittance of the ND filter 51 continuously change from the optical center position (the optical axis of the lens 36) of the ND filter 51 toward the peripheral portion.

Here, “continuously change” includes not only a case where the change is made strictly continuously but also a case where the change is made stepwise (discretely), but the change in each stage is smaller than a predetermined value and is substantially continuous, and existence of various variations caused by design or manufacturing is allowed.

The center gradation characteristic of the light transmittance of the ND filter 51 preferably changes in accordance with the light amount characteristic of the lens 36 provided in the optical path of the optical block 22. That is, the center gradation characteristic of the ND filter 51 is preferably set such that the light transmittance increases from the optical axis toward the peripheral portion, so as to handle the light amount characteristic of the lens 36 that the light amount decreases from the optical center position toward the peripheral portion.

<Optical Characteristic of ND Filter>

Next, in detailed description of the optical characteristic of the ND filter 51, a general optical characteristic of the lens 36 will be described.

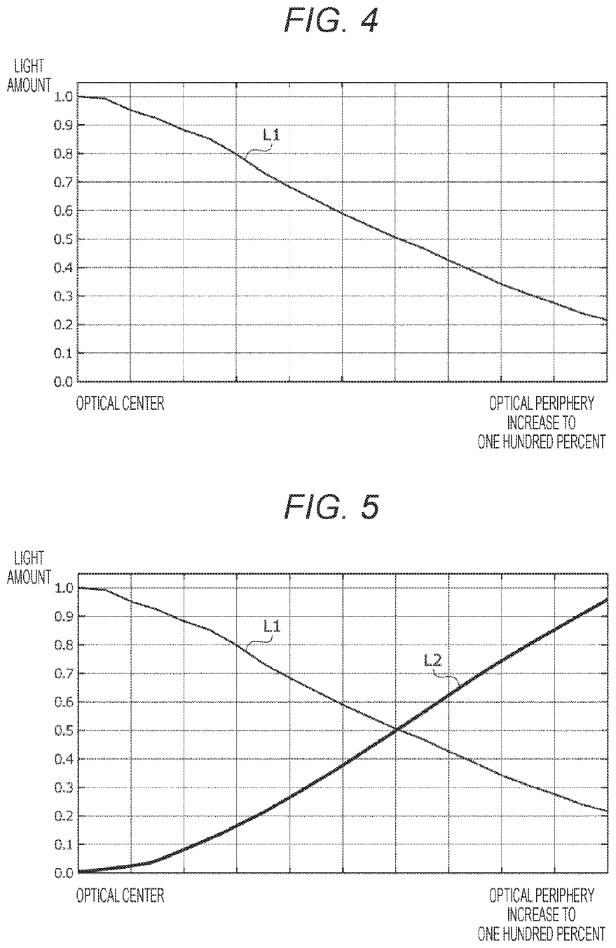

The peripheral light amount characteristic of the general lens 36 arranged in the optical path of the optical block 22 is as indicated by a waveform L1 in FIG. 4, and in a case where the light amount at the optical center position is 100% (1.0 in FIG. 4), the light amount of the peripheral portion decreases to about 20% (0.2 in FIG. 4).

That is, the light amount of the peripheral portion of the lens 36 in the incident light transmitted through the lens 36 decreases by about 80% with respect to the light amount of the central portion of the lens 36.

In other words, the light transmitted through the lens 36 becomes dark to about 20% of the brightness of the central portion of the lens 36.

As described above, the image obtained from the incident light transmitted through the lens 36 becomes a darker image in accordance with the separation from the optical axis toward the peripheral portion, and becomes an image in which the peripheral light amount decreases, and the light amount is nonuniform as a whole.

Heretofore, such a peripheral light amount decrease has been handled by correcting the image signal of the peripheral portion in which the light amount decreases by signal processing.

Note that the waveform L1 in FIG. 4 is a graph illustrating the light amount of the transmitted light of the lens 36 at each distance from the optical axis center, where a vertical axis represents the light amount, and a horizontal axis represents the distance from the optical axis of the lens 36.

More specifically, in the signal processing, the peripheral light amount decrease characteristic is corrected by multiplying the pixel signal of each pixel of the lens 36 by a correction coefficient which changes to increase according to the distance from the optical axis as indicated by a waveform L2 in FIG. 5.

In other words, the waveform L2 in FIG. 5 indicates the change of the correction coefficient according to the distance from the optical axis of the lens 36, and is changed such that a product of the waveform L2 and the waveform L1 indicating the change in the light amount becomes a substantially constant value, whereby a correction is made such that the light amount when the incident light transmitted through the lens 36 is imaged by the solid-state imaging element 31 becomes substantially uniform over the entire imaging surface.

However, in a case where the peripheral light amount decrease is corrected by the signal processing, processing is performed to amplify the image signal of the peripheral portion, in which the light amount decreases, of the image, but this processing amplifies not only the light amount component but also a noise component.

As a result, in the correction process by the signal processing, for example, a noise component, a flaw of the solid-state imaging element 31, fine dust attached to the solid-state imaging element 31, unevenness of the solid-state imaging element 31 and the optical material, and the like are emphasized, and there is a possibility that the yield is reduced.

In this regard, in the present disclosure, in the optical block 22 configuring the camera module 11, the ND filter 51 having such a center gradation characteristic that the light transmittance of at least the peripheral portion (edge portion) of the lens 36 is larger than that in the vicinity of the optical axis (central portion) is provided in the optical path of the incident light incident on the solid-state imaging element 31.

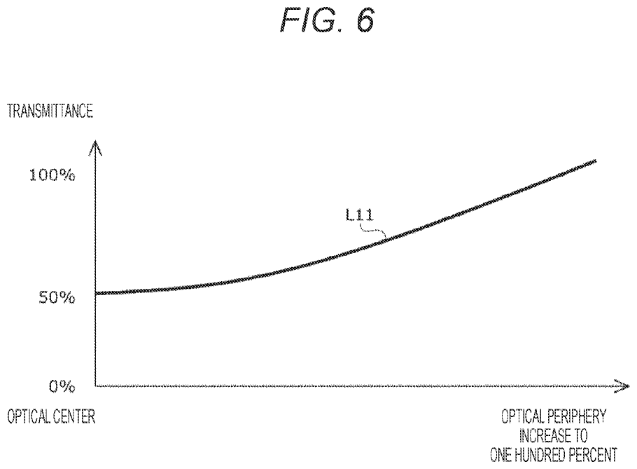

For example, as illustrated in FIG. 6, the center gradation characteristic of the ND filter 51 is a characteristic that the light transmittance is set to 50% at the optical center position of the ND filter 51 corresponding to the optical axis of the lens 36, increases from the optical center position toward the peripheral portion, and is set to approximately 100% at the peripheral portion.

Note that the center gradation characteristic of the ND filter 51 in FIG. 6 is an example, is desirably set in accordance with the light amount characteristic of the lens 36, and is desirably set in accordance with the light amount characteristic of the lens 36.

With such a configuration, in order to solve the small aperture diffraction of the lens 36, instead of correction by signal processing in which a generating noise component, a flaw of the solid-state imaging element, fine dust, and the like are emphasized, an optical correction can be performed to remove non-uniformity of the light amount caused by the peripheral light amount decrease occurring by increasing the aperture of the lens 36.

However, the correction by the signal processing is not denied, and both corrections may be used together by adding the correction by the signal processing together with the optical correction.

That is, a correction in a region of the solid-state imaging element 31 where the optical correction is not sufficient may be supplemented by the correction by the signal processing.

In other words, since the peripheral light amount decrease can be optically corrected, the non-uniformity of the light amount caused by the light amount decrease does not occur even when the aperture of the lens 36 is increased, so that the small aperture diffraction of the lens 36 can be solved.

Then, since the small aperture diffraction of the lens 36 can be solved, it is possible to miniaturize the pixels of the solid-state imaging element 31 including a CCD image sensor, a CMOS image sensor, or the like, and thus, it is possible to capture a high-definition image.

In particular, in the center gradation characteristic of the ND filter 51, the light transmittance increases from the optical axis toward the peripheral portion in accordance with the light amount characteristic of the lens 36, and thus the brightness (luminance) of the image captured by the solid-state imaging element 31 can be made substantially uniform from the optical axis to the peripheral portion.

Therefore, peripheral brightness correction (shading correction) in the optical design of the lens 36 can be alleviated, so that the number of lenses configuring the lens 36 can be reduced, and as a result, cost reduction and height reduction can be achieved.

Furthermore, since the optical design of the shading correction can be alleviated, distortion (image distortion) can be corrected.

<Method of Manufacturing ND Filter having Center Gradation Characteristic>

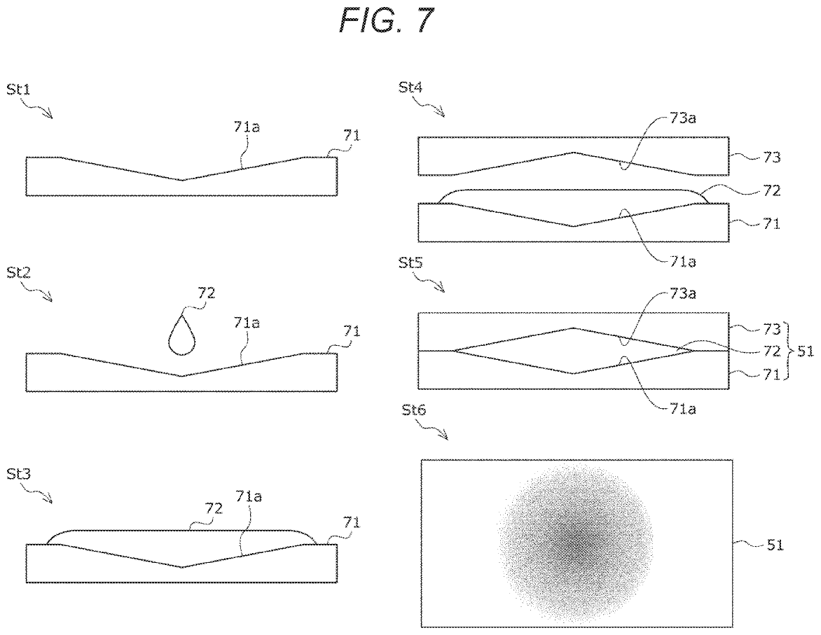

Next, a method of manufacturing the ND filter 51 having the center gradation characteristic will be described with reference to FIG. 7. Note that states St1 to St5 in FIG. 7 are side sectional views when the ND filter 51 is manufactured, and a state St6 is a top view of the ND filter 51 at the time of completion.

In the state St1, a lower member 71 of the ND filter 51 including a recess 71a is placed with the recess 71a as an upper surface. Note that the shape of the recess 71a is desirably a shape corresponding to the light amount characteristic of the lens 36.

In the state St2, a liquid mask material 72 for changing the light transmittance of the incident light is dropped to the recess 71a of the lower member 71.

Then, as indicated by the state St3, the recess 71a is filled with the mask material 72. Note that the light transmittance of the mask material 72 changes according to the thickness of light in an incident direction.

In the state St4, an upper member 73 having a shape similar to the lower member 71 is placed on the lower member 71 from the upper surface such that a recess 73a and the recess 71a face each other. Note that the shape of the recess 73a is also desirably a shape corresponding to the light amount characteristic of the lens 36.

As indicated by the state St5, the lower member 71 and the upper member 73 are bonded to each other such that the mask material 72 is sandwiched between the recesses 71a and 73a.

Then, the lower member 71, the mask material 72, and the upper member 73 are bonded in this order to complete the ND filter 51.

As illustrated in FIG. 7, since the shapes of the recesses 71a and 73a are formed deep at the optical center position and shallow at the peripheral portion, the ND filter 51 is formed to be thick at the optical center position and thin toward the peripheral portion with respect to a transmission direction of the incident light.

As a result, as indicated by the state St6, the ND filter 51 having the center gradation characteristic in which the light transmittance at the optical center position is the lowest and the light transmittance decreases from the optical center position toward the peripheral portion can be manufactured.

Note that the upper member 73 and the lower member 71 are only required to include a material, such as glass, plastic, or a resin forming material, which transmits light.

Furthermore, one plate-shaped member in which the lower member 71 and the upper member 73 are put together may be processed by vapor deposition of the mask material 72 to have the center gradation characteristic, thereby forming the ND filter 51.

However, the processing of applying the mask material 72 to the plate-shaped member by the vapor deposition to have the center gradation characteristic is expensive, and advanced adjustment is required to perform the vapor deposition to have the center gradation characteristic according to the light amount characteristic of the lens 36. Therefore, the ND filter 51 generated by the manufacturing method described with reference to FIG. 7 can realize cost reduction and yield improvement as compared with a case where the center gradation characteristic is realized by the vapor deposition.

<First Application Example of ND Filter in First Embodiment>

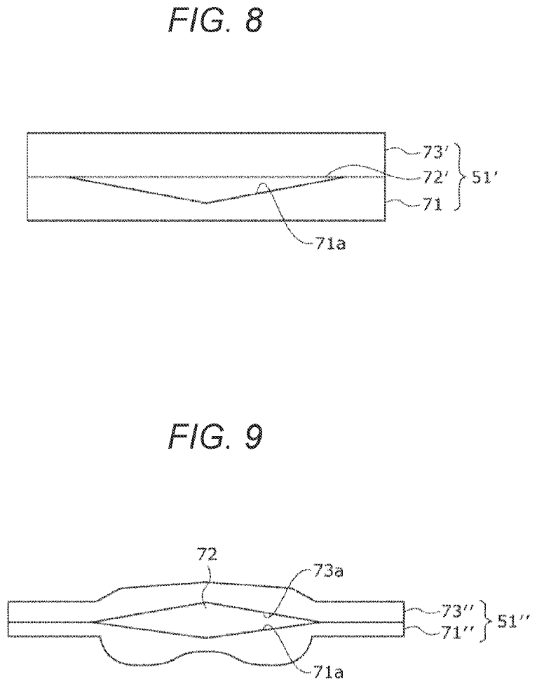

In the above, an example has been described in which the recesses 71a and 73a are provided in both the lower member 71 and the upper member 73. However, for example, as illustrated in FIG. 8, a plate-shaped upper member 73′ in which the recess 73a is not provided may be used instead of the upper member 73 to form an ND filter 51′ in which a mask material 72′ having a planar upper surface is formed.

In the case of the ND filter 51′ in FIG. 8, the thickness of the mask material 72 is adjusted only in the recess 71a of the lower member 71, and thus it is necessary to design the mask material to have a shape corresponding to the light amount characteristic of the lens 36 only in the recess 71a.

<Second Application Example of ND Filter in First Embodiment>

Furthermore, as illustrated in FIG. 9, instead of the lower member 71 and the upper member 73, recesses 71a and 73a may be provided, and an ND filter 51″ including a lower member 71″ and an upper member 73″ which bonded such that a lens shape is integrally formed may be formed.

Note that, in the case of FIG. 9, the ND filter 51″ is configured separately from the IRCF 37, and the ND filter 51″ has a function as a lens, and thus needs to be designed in consideration of an optical characteristic matching the lens 36.

### 2. Second Embodiment

In the above, an example has been described in which the IRCF 37 of the camera module 11 is provided with the ND filter 51 having the center gradation characteristic. However, an imaging device used in a biometric authentication system (imaging system) may also have a similar function.

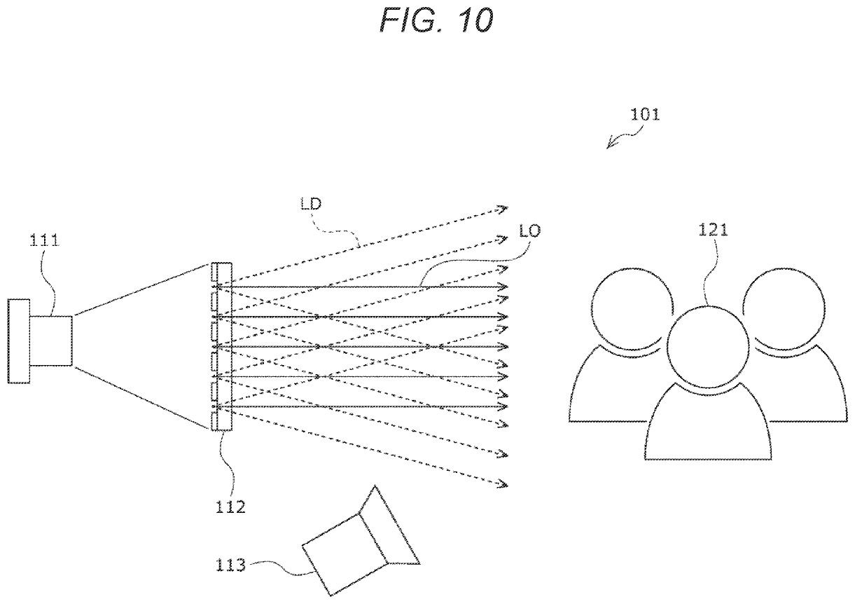

The biometric authentication system has, for example, a configuration as illustrated in FIG. 10.

That is, a biometric authentication system 101 in FIG. 10 includes a light projection device 111, a diffractive optical element (DoE) 112, and an imaging device 113.

The light projection device 111 generates infrared light including laser light and projects the infrared light on a user 121 that is a subject via the DoE 112.

The diffractive optical element (DoE) 112 changes a transmission region to change a diffraction dot pattern of infrared light including a 0-th-order light LO and a diffracted light LD, and causes the infrared light incident from the light projection device 111 to be projected on the user 121 that is the subject.

The imaging device 113 functions as a so-called time-of-flight (ToF) sensor, detects (measures a distance) a distance to the surface of (the face of) the user 121 that is the subject on the basis of a timing at which the infrared light is projected from the light projection device 111 and a timing at which the imaging device 113 receives a predetermined diffraction dot pattern of light reflected on the surface of the user 121 that is the subject and formed by the DoE 112, recognizes an irregularity shape pattern of the surface of the face of the user 121 from the detection pattern of the distance to the surface of the face of the user 121 that is the subject, and authenticates the user.

Here, the imaging device 113 is also provided with the lens 36 similar to the camera module 11 described with reference to FIG. 1.

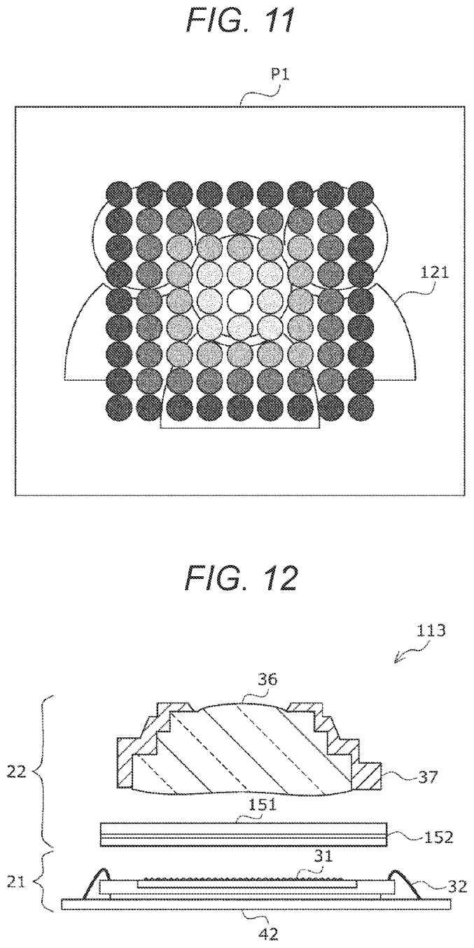

For this reason, when the user 121 that is the subject is imaged as an image P1 in FIG. 11 in the imaging device 113, for example, the center position of the image P1 is imaged brightest, and a darker image is captured in accordance with the separation from the center position to the peripheral portion. Thus, there is a possibility that the authentication process using information in the peripheral portion cannot be performed well, and an authentication error occurs.

Note that circles in the image P1 in FIG. 11 imitate the diffraction dot pattern formed by the DoE 112, each color represents brightness, and the diffraction dot pattern in the vicinity of the image center is represented by a color close to white and indicates to be recognized as a bright image. On the other hand, the diffraction dot pattern in the peripheral portion is represented by a color close to black and indicates to be recognized as a dark image.

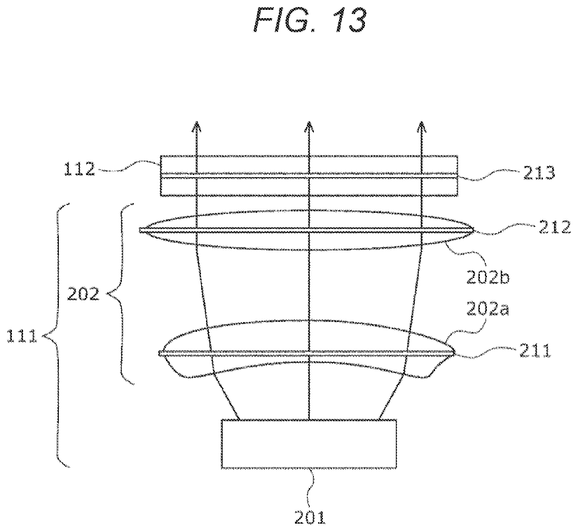

The imaging device 113 is configured, for example, as illustrated in FIG. 12, and a band pass filter (BPF) 151 which transmits infrared light is provided at a preceding stage of the solid-state imaging element 31 in order to receive reflected light including infrared light from the user 121.

Note that FIG. 12 illustrates a peripheral configuration of the solid-state imaging element 31 of the imaging device 113 and a configuration of the lens 36. The same components as those of the camera module 11 in FIG. 1 are denoted by the same reference numerals, and the description thereof will be appropriately omitted.

That is, the imaging device 113 of FIG. 12 is different from the camera module 11 of FIG. 1 in that the BPF 151 which includes the ND filter 152 having the center gradation characteristic and transmits infrared light is provided instead of the IRCF 37 which includes an ND filter 51 having the center gradation characteristic.

In this regard, in the present disclosure, as illustrated in FIG. 12, the ND filter 152 having the center gradation characteristic is included in the BPF 151.

With the configuration as illustrated in FIG. 12, the light transmittance increases from the optical axis of the lens 36 toward the peripheral portion, so that it is possible to realize optical adjustment to obtain uniform luminance (brightness) from the center position (the optical axis of the lens 36) of the image captured by the solid-state imaging element 31 to the peripheral portion.

As a result, a biometric authentication can be performed by the imaging device 113 by using an image in which the brightness of the entire image is uniform, and thus it is possible to reduce an authentication error that occurs in the case of using the image P1 in which the peripheral portion is dark as illustrated in FIG. 11.

<Application Example in Second Embodiment>

In the above, an example has been described in which the ND filter 152 having the center gradation characteristic is provided in the BPF 151 of the imaging device 113 in the biometric authentication system. However, the light projection device 111 used in the biometric authentication system may also have a similar function.

That is, in a case where the ND filter having the center gradation characteristic is not used, as described with reference to FIG. 11, an image is captured in which the vicinity of the optical axis of the lens 36 of the imaging device 113 is bright, and a darker image is captured in accordance with the separation from the optical axis to the peripheral portion. Thus, an error in the biometric authentication is likely to occur.

In this regard, in a range in which infrared light is projected from the light projection device 111, dark infrared light may be projected on the vicinity of the center of the image in which the vicinity of the optical axis of the lens 36 of the imaging device 113 is imaged, and bright infrared light may be projected toward the peripheral portion.

With such a configuration, a dark image is captured in the vicinity of the center of the image captured by the imaging device 113, but a region where the bright light is projected toward the peripheral portion is imaged as a dark image according to the light amount characteristic of the optical block 22, and thus, the captured image as a whole is captured as an image with uniform brightness.

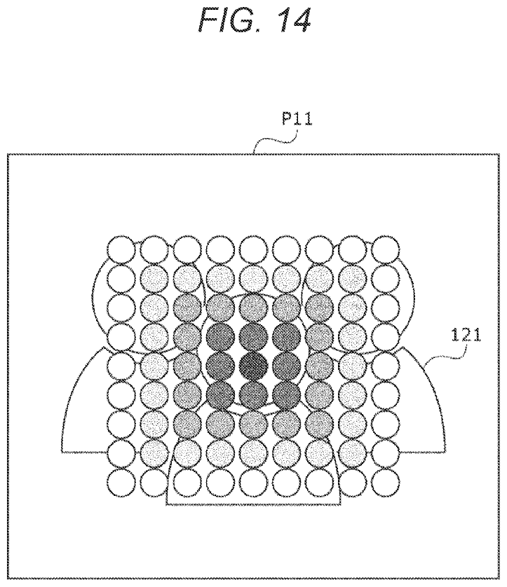

That is, as illustrated in FIG. 13, the light projection device 111 includes a laser light source 201 which generates laser light including infrared light, and a correction lens 202 which converts the laser light emitted from the laser light source 201 into parallel light.

Note that, although FIG. 13 illustrates an example in which the correction lens 202 includes two lenses of lenses 202a and 202b, the correction lens may include another number of lenses other than two lenses.

Then, the DoE 112 is arranged at a subsequent stage of the correction lens 202, and the light including the predetermined diffraction dot pattern emitted from the light projection device 111 is projected on the user 121 that is the subject.

With such a configuration, by providing the ND filters 211, 212, and 213 having the center gradation characteristic in the lenses 202a and 202b configuring the correction lens 202 and the DoE 112, respectively, for example, as illustrated in FIG. 14, infrared light in the state of being dark in the vicinity of the center corresponding to the optical axis of the lens 36 of the imaging device 113 and brightening according to the distance toward the peripheral portion is projected on the user 121 that is the subject.

Note that, in FIG. 14, circles indicate a diffraction dot pattern formed by the DoE 112, and the colors of the circles represent the brightness of the projected infrared light.

By projecting the infrared light including the diffraction dot pattern as illustrated in FIG. 14, a dark image is captured in the vicinity of the center of the image captured by the imaging device 113, but bright light is projected toward the peripheral portion, and thus an image is captured as a dark image according to the light amount characteristic of the lens 36, so that the captured image as a whole is captured as an image with uniform brightness.

As a result, it is possible to capture an image with the brightness of the entire image used for the biometric authentication being uniform, and thus, it is possible to suppress the occurrence of an error in the biometric authentication.

Note that an example has been described in which in the light projection device 111 of FIG. 13, the ND filters 211, 212, and 213 having the center gradation characteristic are provided in the lenses 202a and 202b configuring the correction lens 202 and the DoE 112 respectively. However, the ND filters 211, 212, and 213 having the center gradation characteristic are only required to be provided at least at one or more of the lenses, and need not necessarily be provided at all positions.

However, as a whole, the light transmittance needs to be adjusted such that the user 121 that is the subject is irradiated with infrared light in a light distribution as illustrated in FIG. 14, for example.

Furthermore, in the biometric authentication system, the ND filter 152 having the center gradation characteristic and the ND filters 211, 212 and 213 may be all provided on both the light projection device 111 side and the imaging device 113 side, or at least one or more of them may be provided.

### 3. Third Embodiment

In the above, an example has been described in which in the camera module 11 and the biometric authentication system 101, the ND filters 51, 152, and 211 to 213 having the center gradation characteristics are provided inside the IRCF 37, the BPF 151, the lenses 202a and 202b of the correction lens 202, the DoE 112, and the like. However, as long as the ND filter 51 is provided to optically correct an image to be captured, other configurations may be employed.

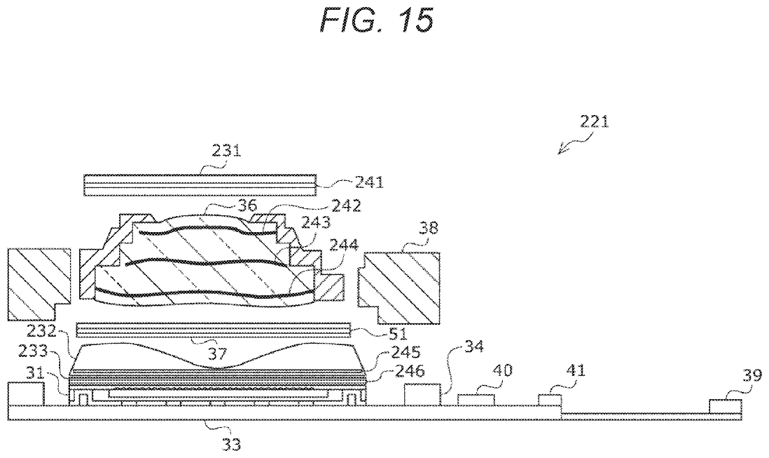

FIG. 15 illustrates a configuration example of another camera module 221 of the camera module 11 in FIG. 1.

Note that, in the camera module 221 in FIG. 15, the same components as those of the camera module 11 in FIG. 1 are denoted by the same reference numerals, and the description thereof will be appropriately omitted.

That is, the camera module 221 in FIG. 15 is different from the camera module 11 in FIG. 1 in that a protective glass 231 is provided on a preceding stage of the lens 36 and in that the solid-state imaging element 31 is formed as a chip size package (CSP), is provided with a wafer level lens (WLL) 233 on the imaging surface, and further is provided with a subsequent stage side lens 232 having the lens 36 as a preceding stage side lens on a preceding stage.

The WLL 233 is a thin lens in units of pixels of the solid-state imaging element 31, the lens 232 configures the optical block 22 together with the lens 36, and incident light from above in the drawing is condensed to form an image on the imaging surface of the solid-state imaging element 31.

In the camera module 221 of FIG. 15, ND filters 241 to 246 having center gradation characteristics are provided.

The ND filter 241 is provided in the protective glass 231.

Furthermore, the ND filters 242 to 244 are provided in the vicinity of the upper stage, the vicinity of the middle stage, and the vicinity of the lower stage in the drawing of the lens 36, respectively.

Moreover, the ND filter 245 is provided between the lens 232 and the WLL 233 (in the glass of the CSP solid-state imaging element 31).

Furthermore, the ND filter 246 is provided in the WLL 233.

That is, in FIG. 15, when the center gradation characteristic is formed by the six ND filters 241 to 246, the transmittance is configured to be the lowest in the vicinity of the optical axis of the lens 36 and to be higher from the optical axis toward the peripheral portion. Then, with such a configuration, the brightness of the entire image captured by the solid-state imaging element 31 can be made uniform.

As a result, it is possible to capture an image having uniform overall brightness.

Furthermore, FIG. 15 illustrates a configuration example in which all six ND filters 241 to 246 are provided, but it is sufficient if at least one of the ND filters is provided.

However, in a case where the portion where the center gradation characteristic is formed is thin and a sufficient change in brightness cannot be applied, it is necessary to form a plurality of pieces to such an extent that a sufficient change in brightness can be obtained.

«4. Modifications»

The solid-state imaging element 31 may be housed in a package.

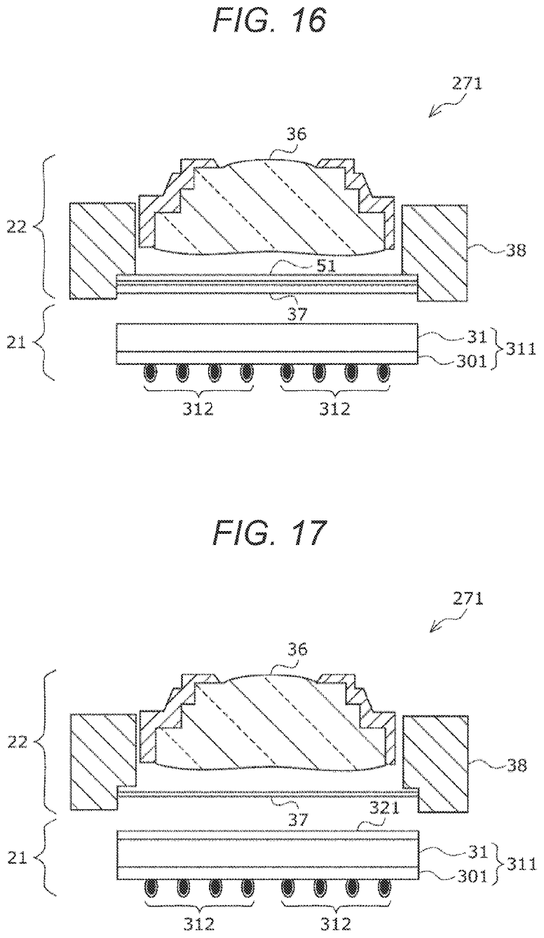

That is, a camera module 271 of FIG. 16 is different from the camera module 11 of FIG. 1, in which the solid-state imaging element 31 is mounted on the circuit board 33 in terms of the configuration, in that the solid-state imaging element 31 is formed on a base substrate 301 to be packaged (housed) in a package 311 including a light transmitting material, and the other configurations are basically the same. Therefore, in the optical block 22, the ND filter 51 has the center gradation characteristic that the value of the light transmittance increases preferably continuously from the optical axis of the lens 36 toward the peripheral portion (in accordance with the separation from the optical axis).

The package 311 which packages the solid-state imaging element 31 is a package mainly including a light transmitting material, for example, glass as material. In the packaging of the solid-state imaging element 31, for example, a wafer level chip size package (WLCSP) semiconductor package technique which performs processing up to packaging in a wafer state can be used.

According to the WLCSP semiconductor package technique, the size of a semiconductor chip obtained by cutting a wafer is the size of the package 311 as it is, and thus the camera module 271 can be reduced in size and weight. The package 311 housing the solid-state imaging element 31 is mounted on the circuit board via a solder bump 312.

Note that, here, a case is exemplified in which the ND filter 51 is formed in the IRCF 37. However, the ND filter may be formed in at least one place in the IRCF 37, similarly to the camera module 11 in FIG. 1, and further, not limited to the IRCF 37, the lens 36 and the protective shield glass of the camera module 271 which are positioned to be separated from the IRCF 37.

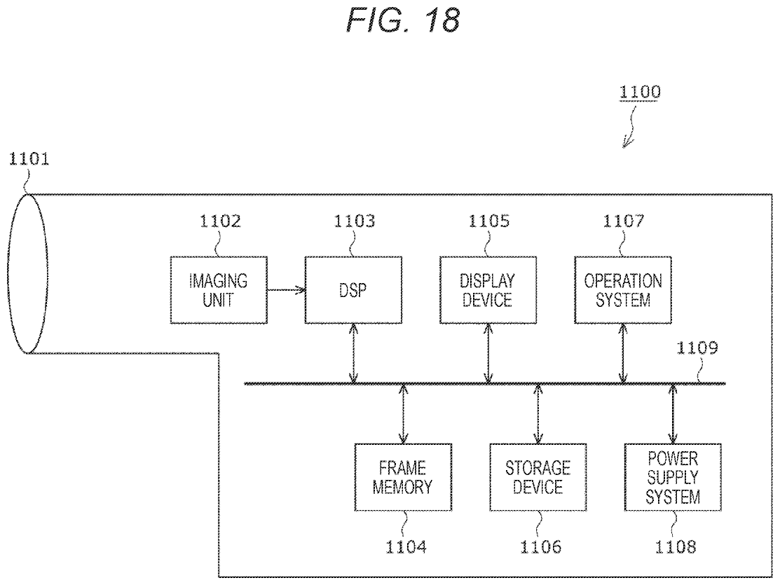

Furthermore, in addition to the IRCF 37 and the lens 36, the ND filter having the center gradation characteristic may be formed as an ND filter 321 on the surface of the package 311 as illustrated in FIG. 17.

Then, in any of a case where the ND filter 321 is formed on the IRCF 37 side, a case where the ND filter is formed on the lens 36 side, and a case where the ND filter is formed on the package 311 side, the formation position of the ND filter can be appropriately changed according to the light amount characteristic, a processing accuracy, and a manufacturing method of the lens 36.

Any of the camera modules 271 in FIGS. 16 and 17 can obtain the operations and effects similar to those of the camera module 11 in FIG. 1. That is, in order to solve the small aperture diffraction of the lens 36, the non-uniformity of the light amount caused by the peripheral light amount decrease occurring by increasing the aperture of the lens 36 can be corrected optically instead of the correction by the signal processing in which a noise component and a flaw, fine dust, or the like of the solid-state imaging element are emphasized, and the light amount in the entire captured image can be made uniform without emphasizing the influence of the noise component, the flaw, the dust, and the like.

«5. Example of application to Imaging Device as Example of Electronic Device of Present Disclosure»

FIG. 18 is a block diagram illustrating a configuration of an imaging device which is an example of an electronic device of the present disclosure. As illustrated in FIG. 18, an imaging device 1100 according to the present example includes an imaging optical system 1101, an imaging unit 1102, a digital signal processor (DSP) circuit 1103, a frame memory 1104, a display device 1105, a recording device 1106, an operation system 1107, a power supply system 1108, and the like. Then, the DSP circuit 1103, the frame memory 1104, the display device 1105, the recording device 1106, the operation system 1107, and the power supply system 1108 are configured to be connected to one another via a bus line 1109.

The imaging optical system 1101 captures incident light (image light) from a subject and forms an image on the imaging surface of the imaging unit 1102. The imaging unit 1102 converts the light amount of the incident light formed on the imaging surface by the optical system 1101 into an electrical signal in units of pixels and outputs the electrical signal as a pixel signal. The DSP circuit 1103 performs general camera signal processing, for example, white balance processing, demosaic processing, gamma correction processing, and the like.

The frame memory 1104 is appropriately used for storing data in the process of the signal processing in the DSP circuit 1103. The display device 1105 includes a panel-type display device such as a liquid crystal display device or an organic electro luminescence (EL) display device, and displays a moving image or a still image captured by the imaging unit 102. The recording device 1106 records the moving image or the still image captured by the imaging unit 1102 on a recording medium such as a portable semiconductor memory, an optical disk, or a hard disk drive (HDD).

The operation system 1107 issues operation commands for various functions of the imaging device 1100 under the operation of the user. The power supply system 1108 appropriately supplies various power sources serving as operation power sources of the DSP circuit 1103, the frame memory 1104, the display device 1105, the recording device 1106, and the operation system 1107 to these supply targets.

In the imaging device 1100 having the above configuration, the camera module according to the first embodiment or the second embodiment described above can be used as the imaging optical system 1101 and the imaging unit 1102. The camera module according to these embodiments can realize uniform brightness from the optical center to the peripheral portion, and thus the optical design of the shading correction can be alleviated in the design of the lens of the imaging optical system 1101, so that the number of lenses can be reduced.

Therefore, when the camera module according to the first embodiment or the second embodiment is used as the imaging optical system 1101 and the imaging unit 1102, the number of lenses can be reduced to achieve cost reduction and height reduction. Furthermore, the problem of small aperture diffraction of a condenser lens can be solved by the technique according to the present disclosure, and accordingly, it is possible to miniaturize the pixels of the solid-state imaging element, and thus, it is possible to capture a high-definition image.

Note that the present disclosure can also have the following configurations.

<1> An imaging device including:

a lens that condenses incident light on an imaging surface of a solid-state imaging element that captures an image; and

a filter that filters the incident light to make a light amount of the image captured by the solid-state imaging element uniform,

in which in the filter, at least a light transmittance in a range away from an optical axis of the lens is larger than a light transmittance in a range in a vicinity of the optical axis.

<2> The imaging device according to <1>,

in which the filter is a neutral density (ND) filter in which a light transmittance increases in accordance with separation from the optical axis of the lens.

<3> The imaging device according to <1>,

in which the light transmittance of the filter increases in accordance with separation from the optical axis of the lens according to a light amount characteristic of the lens.

<4> The imaging device according to <1>,

in which the filter is disposed to be separated from the lens or formed inside the lens.

<5> The imaging device according to any one of <1> to <4>, further including

an infrared cut filter (IRCF) that cuts infrared light included in the incident light,

in which the filter is disposed to be separated from the IRCF or formed in the IRCF.

<6> The imaging device according to any one of <1> to <5>,

in which the filter has a structure in which a lower member and an upper member including a light transmitting material are bonded to each other, and a mask material is sandwiched between the lower member and the upper member, and

a recess to be filled with the mask material is formed in at least one of the lower member and the upper member.

<7> The imaging device according to <6>,

in which a shape of the recess becomes deep at the optical axis of the lens and becomes shallow in accordance with separation from the optical axis of the lens toward a peripheral portion.

<8> The imaging device according to <6>,

in which a shape of the recess is a shape based on a light amount characteristic of the lens.

<9> The imaging device according to <6>,

in which the upper member and the lower member are bonded to configure a lens that condenses the incident light on the imaging surface of the solid-state imaging element.

<10> The imaging device according to any one of <1> to <9>,

in which the solid-state imaging element is stored in a package including a light transmitting material.

<11> A camera module including:

a lens that condenses incident light on an imaging surface of a solid-state imaging element that captures an image; and

a filter that filters the incident light to make a light amount of the image captured by the solid-state imaging element uniform,

in which in the filter, at least a light transmittance in a range away from an optical axis of the lens is larger than a light transmittance in a range in a vicinity of the optical axis.

<12> An electronic device including:

a lens that condenses incident light on an imaging surface of a solid-state imaging element that captures an image; and

a filter that filters the incident light to make a light amount of the image captured by the solid-state imaging element uniform,

in which in the filter, at least a light transmittance in a range away from an optical axis of the lens is larger than a light transmittance in a range in a vicinity of the optical axis.

<13> An imaging system including:

a light projection device that projects predetermined light on a subject; and

an imaging device that condenses, by a lens, incident light from the subject on which the predetermined light is projected and captures an image,

in which the light projection device includes
a filter that filters the predetermined light such that a light amount of the image of the subject captured by condensing by the lens is made uniform and projects the predetermined light on the subject.

<14> The imaging system according to <13>,

in which the filter is a neutral density (ND) filter in which a light transmittance increases in accordance with separation from the optical axis of the lens.

<15> The imaging system according to <13>,

in which the light transmittance of the filter increases in accordance with separation from the optical axis of the lens according to a light amount characteristic of the lens.

<16> The imaging system according to any of <13> to <15>,

in which the light projection device further includes

a correction lens that converts the predetermined light into parallel light, and

the filter is configured to be separated from the correction lens or in the correction lens.

<17> The imaging system according to any one of <13> to <16>,

in which the predetermined light is infrared light,

the light projection device further includes a pattern forming unit that forms a diffraction dot pattern by using the infrared light, and

the filter is configured to be separated from the pattern forming unit or in the pattern forming unit.

<18> The imaging system according to <17>,

in which the subject is a face of a user, and

the imaging device detects an irregularity of the face of the user on the basis of the diffraction dot pattern emitted on the subject and formed by using the infrared light, and authenticates the user.

<19> The imaging system according to <18>,

in which the imaging device includes a time of flight (ToF) sensor, and

the irregularity of a surface of the face of the user is detected on the basis of a measurement result of a distance to the surface of the face of the user by the ToF sensor using the diffraction dot pattern emitted on the subject and formed by using the infrared light, and the user is authenticated.

<20> The imaging system according to <17>, further including

a band pass filter (BPF) that transmits the infrared light included in the incident light,

in which the filter is disposed to be separated from the BPF or formed in the BPF.

### REFERENCE SIGNS LIST

11 Camera module

21 Imaging block

22 Optical block

31 Solid-state imaging element

32 Metal wire

33 Circuit board

34 Spacer

35 Adhesive

36 Lens

37 IR cut filter (IRCF)

38 Holder

39 Connector

40 LSI

41 Storage unit

42 Plate

51, 51′, 51″ ND filter

71, 71′, 71″ Lower member

71a Recess

72, 72′ Mask material

73, 73′, 73″ Lower member

73a Recess

101 Biometric authentication system

111 Light projection unit

112 DoE

113 Imaging device

121 User

151 Band Pass Filter (BPF)

152 ND filter

201 Laser light source

202 Correction lens

202a, 202b Lens

211, 212, 213 ND filter

221 Camera module

231 Protective glass

232 Lens

233 Wafer level lens (WLL)

241 to 246 ND filter

271 Camera module

311 Package

312 Solder bump

1. An imaging device comprising:
a lens that condenses incident light on an imaging surface of a solid-state imaging element that captures an image; and
a filter that filters the incident light to make a light amount of the image captured by the solid-state imaging element uniform,
wherein in the filter, at least a light transmittance in a range away from an optical axis of the lens is larger than a light transmittance in a range in a vicinity of the optical axis.

2. The imaging device according to claim 1,
wherein the filter is a neutral density (ND) filter in which a light transmittance increases in accordance with separation from the optical axis of the lens.

3. The imaging device according to claim 1,
wherein the light transmittance of the filter increases in accordance with separation from the optical axis of the lens according to a light amount characteristic of the lens.

4. The imaging device according to claim 1,
wherein the filter is disposed to be separated from the lens or formed inside the lens.

5. The imaging device according to claim 1, further comprising
an infrared cut filter (IRCF) that cuts infrared light included in the incident light,
wherein the filter is disposed to be separated from the IRCF or formed in the IRCF.

6. The imaging device according to claim 1,
wherein the filter has a structure in which a lower member and an upper member including a light transmitting material are bonded to each other, and a mask material is sandwiched between the lower member and the upper member, and
a recess to be filled with the mask material is formed in at least one of the lower member and the upper member.

7. The imaging device according to claim 6,
wherein a shape of the recess becomes deep at the optical axis of the lens and becomes shallow in accordance with separation from the optical axis of the lens toward a peripheral portion.

8. The imaging device according to claim 6,
wherein a shape of the recess is a shape based on a light amount characteristic of the lens.

9. The imaging device according to claim 6,
wherein the upper member and the lower member are bonded to configure a lens that condenses the incident light on the imaging surface of the solid-state imaging element.

10. The imaging device according to claim 1,
wherein the solid-state imaging element is stored in a package including a light transmitting material.

11. A camera module comprising:
a lens that condenses incident light on an imaging surface of a solid-state imaging element that captures an image; and
a filter that filters the incident light to make a light amount of the image captured by the solid-state imaging element uniform,
wherein in the filter, at least a light transmittance in a range away from an optical axis of the lens is larger than a light transmittance in a range in a vicinity of the optical axis.

12. An electronic device comprising:
a lens that condenses incident light on an imaging surface of a solid-state imaging element that captures an image; and
a filter that filters the incident light to make a light amount of the image captured by the solid-state imaging element uniform,
wherein in the filter, at least a light transmittance in a range away from an optical axis of the lens is larger than a light transmittance in a range in a vicinity of the optical axis.

13. An imaging system comprising:
a light projection device that projects predetermined light on a subject; and
an imaging device that condenses, by a lens, incident light from the subject on which the predetermined light is projected and captures an image,
wherein the light projection device includes
a filter that filters the predetermined light such that a light amount of the image of the subject captured by condensing by the lens is made uniform and projects the predetermined light on the subject.

14. The imaging system according to claim 13,
wherein the filter is a neutral density (ND) filter in which a light transmittance increases in accordance with separation from the optical axis of the lens.

15. The imaging system according to claim 13,
wherein the light transmittance of the filter increases in accordance with separation from the optical axis of the lens according to a light amount characteristic of the lens.

16. The imaging system according to claim 13,
wherein the light projection device further includes
a correction lens that converts the predetermined light into parallel light, and
the filter is configured to be separated from the correction lens or in the correction lens.

17. The imaging system according to claim 13,
wherein the predetermined light is infrared light,
the light projection device further includes a pattern forming unit that forms a diffraction dot pattern by using the infrared light, and
the filter is configured to be separated from the pattern forming unit or in the pattern forming unit.

18. The imaging system according to claim 17,
wherein the subject is a face of a user, and
the imaging device detects an irregularity of the face of the user on a basis of the diffraction dot pattern emitted on the subject and formed by using the infrared light, and authenticates the user.

19. The imaging system according to claim 18,
wherein the imaging device includes a time of flight (ToF) sensor, and
the irregularity of a surface of the face of the user is detected on a basis of a measurement result of a distance to the surface of the face of the user by the ToF sensor using the diffraction dot pattern emitted on the subject and formed by using the infrared light, and the user is authenticated.

20. The imaging system according to claim 17, further comprising
a band pass filter (BPF) that transmits the infrared light included in the incident light,
wherein the filter is disposed to be separated from the BPF or formed in the BPF.
